(19) United States
(12) Patent Application Publication
(10) Pub. No.: US 2009/0165259 A1
(43) Pub. Date: Jul. 2, 2009

(54) Blade paper clip of a variety of shape and with a shorter front blade and a longer fenestrated back blade

(76) Inventors: Kun Yuan Tong, Suwanee, GA (US); David Tong, Atlanta, GA (US)

Correspondence Address: Kun Yuan Tong, 2842 Lowe Court, Suwanee, GA, 30024, US

(21) Appl. No.: 12/006,002

(22) Filed: Dec. 29, 2007

(51) Int. Cl. B42F 1/02

(52) U.S. Cl. 24/67.9

(57) ABSTRACT

A blade paper clip of a variety shape with a shorter front blade and a longer fenestrated back blade consists of a shorter front blade and a longer fenestrated back blade. The shorter front blade and the longer fenestrated back blade are connected together at their apex by shoulder or shoulders. It can be made of steel or plastic. It also can be of a variety of shape for fun or for easily locating the stored documents. It also can be of a variety of color. The width of the shorter front blade can be equal to or wider than that of the longer fenestrated back blade. The long fenestrated back blade has a window large enough to admit a finger tip to facilitate opening the blade paper clip.

### THE BACKGROUND OF THE INVENTION

Jim's paper clip is made of steel wire and is of only one shape of coil. The present invented blade paper clip of a variety of shape and with a shorter front blade and a longer fenestrated back blade is made of steel or plastic and is of a variety of shape. It also can have printed letter of alphabet or number or pictures on the front blade. It is convenient for user to classify and to identify the nature of documents with the present invented blade paper clip of variety of shape with letters of alphabet or number or picture.

### THE BRIEF SUMMARY OF THE INVENTION

The present invented blade paper clip of a variety of shape and with a shorter front blade and a longer fenestrated back blade is made of steel or plastic. The shorter front blade and longer fenestrated back blade facilitate the opening of this paper clip to clip papers. Its front blade can have printed alphabet or number or picture to let user to categorize and to identify the nature of documents. It is of a variety of shape and color for fun and for easily locating the needed documents.

### THE DETAIL DESCRIPTION OF THE DRAWINGS

FIG. 1 is a perspective view of blade paper clip of lamp shape and with a shorter front blade that has a printed letter of A and a longer fenestrated back blade.

FIG. 2 is a perspective view of the back of a blade paper clip of lamp shape and with a shorter front blade that has a printed letter of A and a longer fenestrated back blade.

FIG. 3 is a perspective view of blade paper clip of apron shape with a shorter front blade that has a printed number of 77 and a longer fenestrated back blade.

FIG. 4 is a perspective view of the back of blade paper clip of apron shape and with a shorter front blade that has a printed number of 77 and a longer fenestrated back blade.

FIG. 5 is a perspective view of a blade paper clip of foot ball shape and with a shorter front blade that has printed word of BALL and a longer fenestrated back blade.

FIG. 6 is a perspective view of the back of a blade paper clip of foot ball shape and with a shorter front blade that has printed word of BALL and a longer fenestrated back blade.

FIG. 7 is a perspective view of a blade paper clip of A-shape letter and with a shorter front blade and a longer fenestrated back blade.

FIG. 8 is a perspective view of the back of a blade paper clip of A-shaped letter and with a shorter front blade and a longer fenestrated back blade

FIG. 9 is a perspective view of a blade paper clip of Christmas tree shape and with a shorter front blade and a longer fenestrated back blade.

FIG. 10 is a perspective view of the back of a blade paper clip of Christmas tree shape and with a shorter front blade and a longer fenestrated back blade.

### THE DETAIL DESCRIPTION OF THE INVENTION

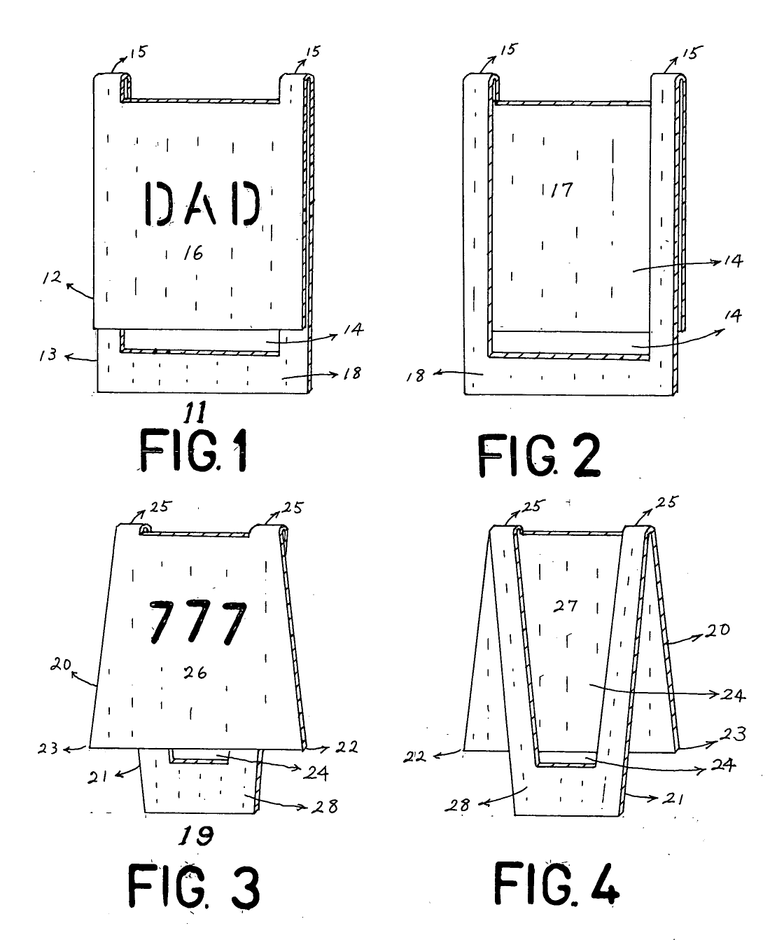

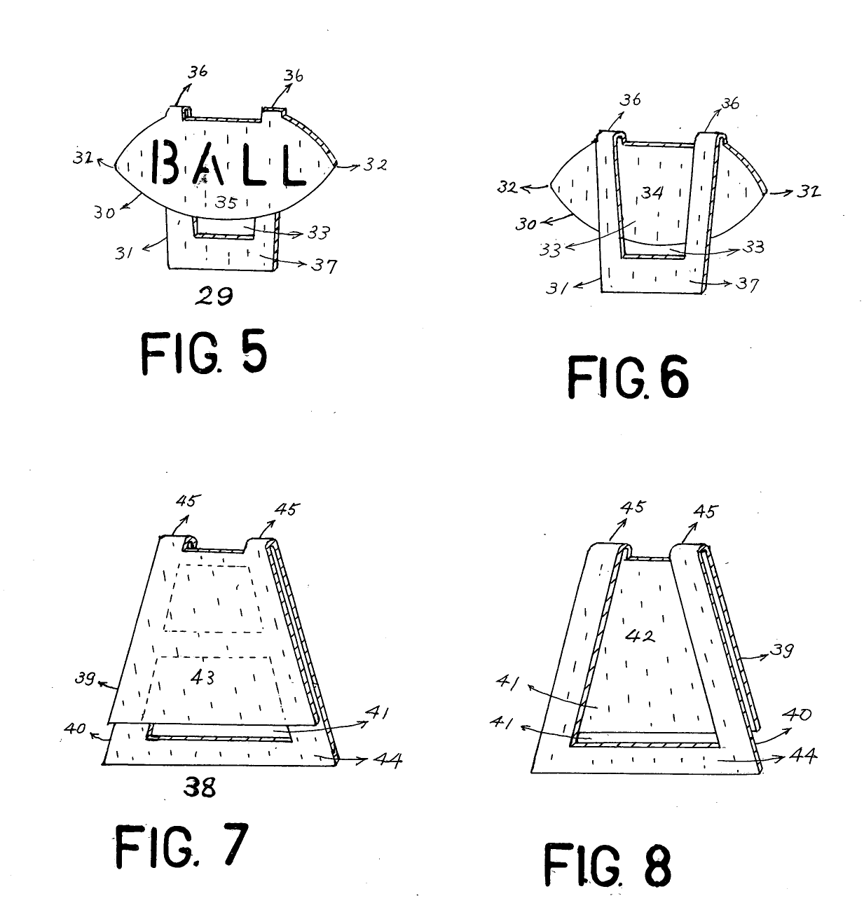

Referring now in detail to the drawings numeral 11 of FIG. 1 is a blade paper clip of apron shape with a shorter front blade 12 and a longer fenestrated short blade 13. Numeral 12 of FIGS. 1 and 2 is the front blade that is shorter than the longer fenestrated back blade 13 and has a printed word of DAD on it. Numeral 13 of FIGS. 1 and 2 is the longer fenestrated back blade that is longer than the shorter front blade 12 and has a window 14. Numeral 15 of FIGS. 1 and 2 are shoulders that connect the shorter front blade 12 and the longer fenestrated back blade 13. The shorter front blade 12 and the longer fenestrated back blade 13 facilitate the opening of the paper clip 11. When to clip a stack of paper user first grasps the blade paper clip 11 by placing his/her thumb on the top 16 of the shorter front blade 12 and index finger on the back 17 of the shorter front blade 12 through the window 14. Secondly user places the end 18 of the longer fenestrated back blade 13 under and against the stack of paper and pushes upward the back 17 of the shorter front blade 12 to open blade paper clip 11. Thirdly user pushed the stack of paper into and between the blades 12 and 13 of blade of paper clip 11 toward shoulders to complete paper clipping. Numeral 19 of FIG. 3 is a blade paper clip of lamp shape and with a shorter front blade 20 and a longer fenestrated back blade 21. The shorter front blade 20 is of lamp shape and has a printed number of 777 and two lower corners 22 and 23. The longer fenestrated back blade 21 has a window 24. Numeral 25 of FIGS. 3 and 4 are shoulders that connect the shorter front blade 20 and the longer fenestrated back blade 21. The shorter front blade 20 of FIGS. 3 and 4 has a front surface 26 and a back surface 27. The longer fenestrated back blade 21 has an end 28. When to clip a stack of paper user first grasp the blade paper clip of lamp shape 19 by placing his/her thumb on the front surface 26 and index finger on the back 27 of the shorter front blade 21 through the window 24 of the longer fenestrated blade 21. Secondly user places the end 28 of the longer fenestrated back blade 21 under and against the stack of paper and then pushes upward the back surface 27 of the shorter front blade 20 to open blade paper clip 19. Thirdly user pushes the stack of paper into and between blades 20 and 21 of blade paper clip 19 toward shoulders 25 to clip this stack of paper. There is another way to use this blade paper clip of lamp shape 190. First user grasps the two lower corners 22 and 23 of blade paperclip of lamp shape 19 with his/her thumb and index or other finger. Secondly user places the end 28 of the longer fenestrated back blade 21 under and against a stack of paper and then lift upward the two lower corners 22 and 23 against the stack of paper to open blade paper clip of lamp shape 19. Thirdly user pushes the stack of paper into and between blades 20 and 21 and push it toward the shoulders 25 to complete clipping this stack of paper. Numeral 29 of FIG. 5 is a blade paper clip of foot ball shape that consists of a wider and shorter front blade 30 and a longer fenestrated back blade 31. The wider and shorter front blade 30 has two identical corners 32. The longer fenestrated back blade 31 has a window 33 as illustrated in FIGS. 5 and 6. Numeral 34 of FIG. 6 is the back surface of the wider and shorter front blade 30. Numeral 35 of FIG. 5 is the front surface of the wider and shorter front blade 30. There is a word of BALL printed on the front surface 35 of the wider and shorter front blade 30 of blade paper clip of foot ball shape 29. There are two shoulders 36 of FIGS. 5 and 6 of a blade paper clip of foot ball shape 29 to connect the wider and shorter front blade 30 and the longer fenestrated back blade 31. Numeral 37 of FIGS. 5 and 6 is the end of the longer fenestrated back blade of foot-ball shape 29. The way to use a blade paper clip of foot ball shape 29 is like the way to use a blade paper clip of lamp shape 19. Numeral 38 of FIG. 7 is a blade paper clip of A shape that consists of a shorter front blade 39 and a longer fenestrated back blade 40. The shorter front blade 39 of blade paper clip of A shape 38 has a shape of A.

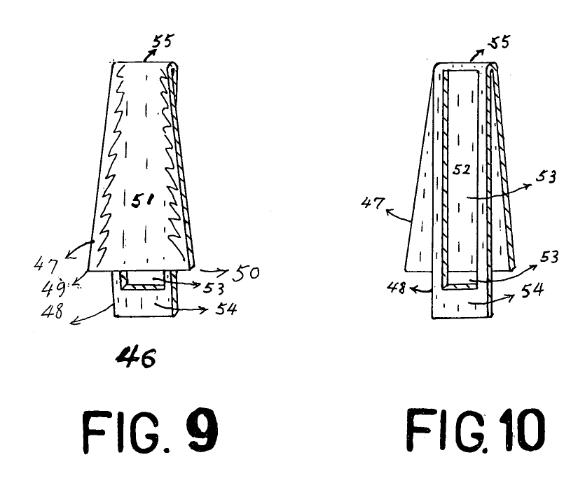

The longer fenestrated back blade 40 has a window 41. The shorter front blade 39 of FIGS. 7 and 8 has a back surface 42 and a front surface 43. Numeral 44 of FIGS. 7 and 8 is the end of the longer fenestrated back blade 40. Numeral 45 of FIGS. 7 and 8 are shoulders of blade paper clip of A shape that connect the shorter front blade 39 and the longer fenestrated back blade 340. The way to use a blade paper clip of A shape is like the way to use a blade paper clip of apron shape 11 with a shorter front blade 12 and a longer fenestrated back blade 13. Numeral 46 of FIG. 9 is a blade paper clip of Christmas shape that has a shorter and wider front blade 47 and a longer fenestrated back blade 48. The shorter and wider blade 47 of FIGS. 9 and 10 has two angles 49 and 50 to be grasped by thumb and other finger, a front surface 51 and a back surface 52. The longer fenestrated back blade 48 of FIG. 10 has a window 53 and a lower end 54. Numeral 55 of FIGS. 9 and 10 is shoulder to connect the shorter and wider front blade 47 and longer fenestrated back blade 48. When to use this blade paper clip of Christmas shape 46, user does it like the way to clip paper with an apron-shaped blade paper clip 11 of FIG. 1 or does it like the way to clip paper with a lamp-shaped blade paper clip 19 of FIG. 3.

1. A blade paper clip of a variety of shape with a shorter front blade and a longer fenestrated back blade comprising a shorter front blade, shoulder and a longer fenestrated back blade.

2. The said a variety of shape in claim 1 including figure of things, letter of alphabet, letter of number and word, etc.

3. The said shorter front blade in claim 1 comprising a blade that is shorter than the said longer fenestrated back blade in claim 1 and is of the same width or wider than that of the said longer fenestrated back blade in claim 1.

4. The said shoulder in claim 1 can be one or two or multiple shoulders that connects or connect the said a shorter front blade in claims 1 and 3 and the said longer fenestrated back blade in claims 1 and 3 at their apexes.

5. The said a longer fenestrated back blade in claims 1,3, and 4 comprising a blade that is longer than the said shorter front blade in claims 1, 3, and 4 and has a window in the center. Wherein the said window is large enough to admit a finger tip to facilitate opening the said blade paper clip in claim 1.
